(19) United States
(12) Patent Application Publication
(10) Pub. No.: US 2010/0328846 A1
(43) Pub. Date: Dec. 30, 2010

(54) Electrode for electric double layer capacitor, method of manufacturing the same, and electric double layer capacitor

(75) Inventors: Sung Ho Lee, Seongnam (KR); Hyun Chul Jung, Yongin (KR); Chang Ryul Jung, Seoul (KR); Yeong Su Cho, Guri (KR)

Correspondence Address: STAAS & HALSEY LLP, SUITE 700, 1201 NEW YORK AVENUE, N.W., WASHINGTON, DC, 20005, US

(73) Assignee: Samsung Electro-Mechanics Co., Ltd., Suwon (KR)

(21) Appl. No.: 12/654,534

(22) Filed: Dec. 22, 2009

(30) Foreign Application Priority Data
Jun. 26, 2009 (KR) 10-2009-0057839

(51) Int. Cl. H01G 9/00

(52) U.S. Cl. 361/502; 427/80

(57) ABSTRACT

An electrode for an electric double layer capacitor includes a current collector including an aluminum (Al) foil layer and a highly conductive metal layer having a higher conductivity than Al and laminated on the Al foil layer, a groove formed in the Al foil layer to cause the highly conductive metal layer to contact an electrode material, and an electrode layer formed of the electrode material on the groove and the Al foil layer.

### CROSS-REFERENCE TO RELATED APPLICATIONS

This application claims the priority of Korean Patent Application No. 10-2009-0057839 filed on Jun. 26, 2009, in the Korean Intellectual Property Office, the disclosure of which is incorporated herein by reference.

### BACKGROUND OF THE INVENTION

1. Field of the Invention

The present invention relates to an electrode for an electric double layer capacitor, a method of manufacturing the same and an electric double layer capacitor, and more particularly, to an electrode for an electric double layer capacitor having an improved current-collector structure or including a current collector having a surface coated with a highly conductive material in order to acquire equivalent series resistance (ESR), a method of manufacturing the same and an electric double layer capacitor.

2. Description of the Related Art

An electric double layer capacitor is an energy storage device that uses a pair of electrode layers (charge layers) having opposite polarities. This electric double layer capacitor has characteristics such as quick charge/discharge, high resistance to over-charge/discharge, a long useful life span due to no accompanying chemical reactions, usability in a wide range of temperatures, and the prevention of environmental pollution due to no heavy metal content.

Recently, the application range of electric double layer capacitors has expanded from systems requiring independent power supply units, control systems for momentary overload and energy storage units to backup power sources which are backup power sources operating at the time of momentary power failure.

In general, an electric double layer capacitor includes a pair of polarizing electrode layers, a separator interposed between the electrode layers to divide the electrode layers into an anode and a cathode, an aqueous electrolyte solution and a non-aqueous electrolyte solution with which the polarizing electrode layers are respectively impregnated, and a current collector collecting charges.

Low ESR is necessary in order to enhance the performance of the electric double layer capacitor. To obtain low ESR, structures for increasing the specific surface area of activated carbon used as an electrode material are being proposed.

In particular, aluminum (Al) foil having a porous surface is used as a current collector, and activated carbon, the electrode material, is provided into the pores of the porous surface, thereby reducing ESR.

However, acquiring lower ESR than that by the above ESR reduction method needs to be studied so as to diversify the applicability of electric double layer capacitors and ensure high electric capacity thereof.

### SUMMARY OF THE INVENTION

An aspect of the present invention provides an electrode for an electric double layer capacitor, which can realize low ESR by changing the structure of a current collector in a way that reduces charge-transfer resistance, a method of manufacturing the same, and an electric double layer capacitor.

An aspect of the present invention also provides an electrode for an electric double layer capacitor, which can realize low ESR by placing a material, having a higher conductivity than an electrode material, between a current collector and the electrode material, a method of manufacturing the same, and an electric double layer capacitor.

According to an aspect of the present invention, there is provided an electrode for an electric double layer capacitor, the electrode including: a current collector including an aluminum (Al) foil layer and a highly conductive metal layer having a higher conductivity than Al and laminated on the Al foil layer; a groove formed in the Al foil layer to cause the highly conductive metal layer to contact an electrode material; and an electrode layer formed of the electrode material on the groove and the Al foil layer.

The groove of the Al foil layer may have a rough surface.

The groove may be formed by using etching to expand a contact area of the Al foil layer with the electrode material.

The current collector may include another Al foil layer laminated on the highly conductive metal layer on the Al foil layer.

The highly conductive metal layer may be formed of any one selected from the group consisting of Cu, Ag, Au and Pt.

The electrode material may include: a highly conductive polymer material directly contacting the highly conductive metal layer; and an activated carbon electrode material coated on the polymer material.

According to another aspect of the present invention, there is provided an electric double layer capacitor including: a plurality of electrode cells, each including a current collector including an Al foil layer and a highly conductive metal layer having a higher conductivity than Al and laminated on the Al foil layer, electrode layers each formed of an electrode material contacting the highly conductive metal layer, and a separator separating the electrode layers; an internal electrode cell formed by successively laminating the plurality of electrode cells; and a metal case filled with an electrolyte solution and receiving the internal electrode cell.

A groove may be formed in the Al foil layer and have a rough surface.

The groove may be formed using etching to expand a contact area of the Al foil layer with the electrode material.

The current collector may include another Al foil layer laminated on the highly conductive metal layer disposed on the Al foil layer.

The highly conductive metal layer may be formed of any one selected from the group consisting of Cu, Ag, Au and Pt.

The electrode material may include: a highly conductive polymer material directly contacting the highly conductive metal layer; and an activated carbon electrode material coated on the polymer material.

According to another aspect of the present invention, there is provided a method of manufacturing an electrode for an electric double layer capacitor, the method including: providing a highly conductive metal layer on an Al foil layer to prepare a current collector; forming a groove in a surface of the Al foil layer, the groove communicating with the highly conductive metal layer; and injecting an electrode material into the groove to coat the groove and the Al foil layer with the electrode material.

The forming of the groove in the surface of the Al foil layer may include roughening the surface of the groove of the Al foil layer by using etching.

The current collector may include another Al foil layer laminated on the highly conductive metal layer disposed on the Al foil layer.

The highly conductive metal layer may be formed of any one selected from the group consisting of Cu, Ag, Au and Pt.

The electrode material may include: a highly conductive polymer material directly contacting the highly conductive metal layer; and an activated carbon electrode material coated on the polymer material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view illustrating an electric double layer capacitor according to an exemplary embodiment of the present invention;

FIG. 2 is a schematic perspective view illustrating one example of an electrode cell inside an electric double layer capacitor according to an exemplary embodiment of the present invention;

FIG. 3 is a schematic perspective view illustrating one example of laminated electrode cells inside an electric double layer capacitor according to an exemplary embodiment of the present invention;

FIGS. 4A through 4C are schematic views illustrating a method of manufacturing an electrode for an electric double layer capacitor according to an exemplary embodiment of the present invention;

FIG. 5 is a schematic view illustrating the flow of charges in an electrode for an electric double layer capacitor, which is manufactured according to an exemplary embodiment of the present invention; and

FIG. 6 is a schematic view illustrating that a highly conductive polymer material is applied on an Al foil layer before an electrode layer is formed of an activated carbon electrode material in manufacturing an electrode for an electric double layer capacitor according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Like reference numerals in the drawings denote like elements, and thus their description will be omitted.

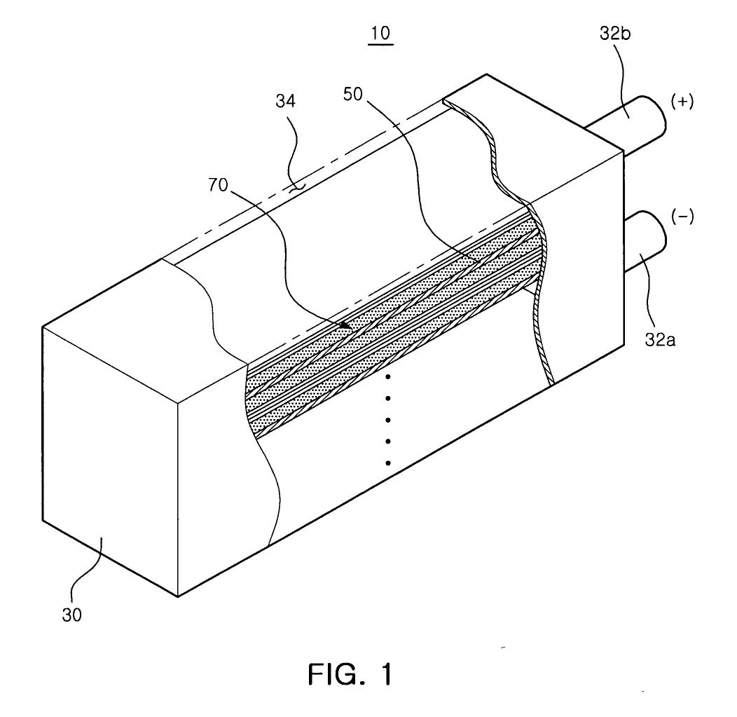

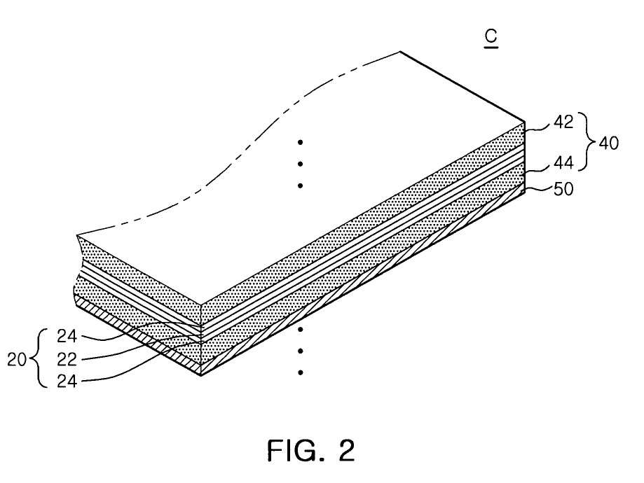

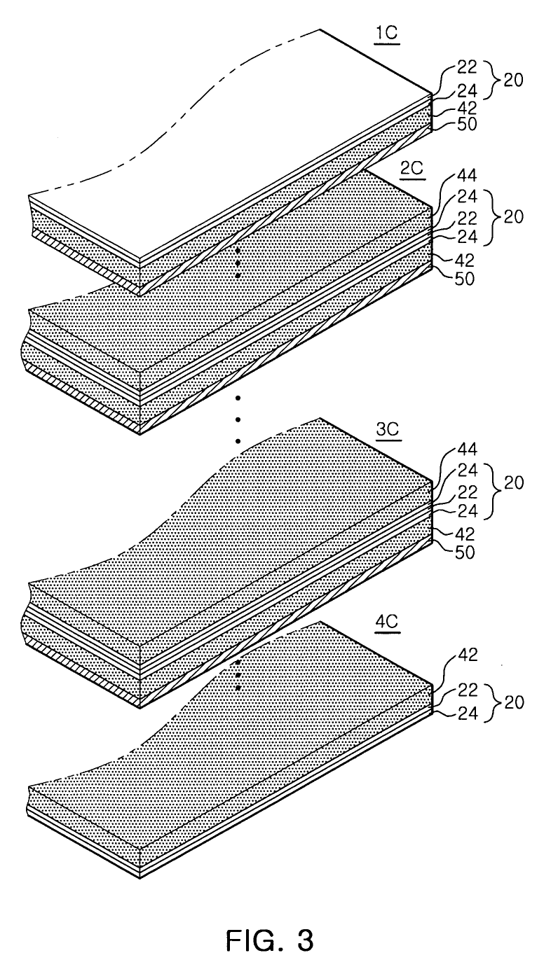

FIG. 1 is a partially cut-away perspective view illustrating an electric double layer capacitor according to an exemplary embodiment of the present invention. FIG. 2 is a schematic perspective view illustrating one example of an electrode cell inside an electric double layer capacitor according to an exemplary embodiment of the present invention. FIG. 3 is a schematic perspective view illustrating one example of laminated electrode cells inside an electric double layer capacitor according to an exemplary embodiment of the present invention;

Referring to FIGS. 1 through 3, an electric double layer capacitor 10, according to an exemplary embodiment, includes a plurality of electrode cells 1C to 4C, an internal electrode cell 70 formed by successively laminating the plurality of cells 1C to 4C, and a metal case 30 filled with an electrolyte solution 34 and receiving the internal electrode cell 70.

The electrode cell C is one base unit in the internal electrode cell 70 of the electric double layer capacitor 10, and includes a current collector 20, an electrode layer 40 including first and second electrode layers 42 and 44, and a separator 50 separating the first and second electrode layers 42 and 44 from each other so as to prevent a short-circuit.

The current collector 20 includes an Al foil layer 24 and a highly conductive metal layer 22 having a higher conductivity than Al and laminated on the Al foil layer 24. Here, the highly conductive metal layer 22 refers to a metal having a higher conductivity than Al, and may be any one selected from the group consisting of Cu, Ag, Au and Pt in this embodiment.

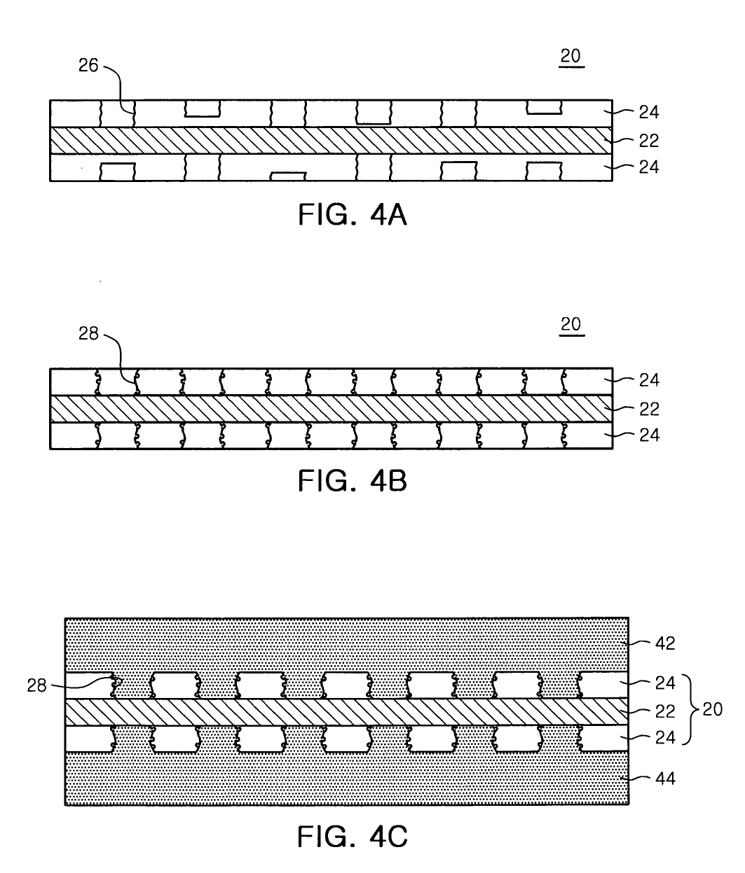

Grooves 26 (see FIG. 4A) are formed in the Al foil layer 24 in order to allow an electrode material to contact the highly conductive metal layer 22.

According to the location of the current collector 20 in the metal case 30, the highly conductive metal layer 22 may be laminated on one surface of the Al foil layer 24 or may be disposed between the Al foil layer 24 and another foil layer 24.

The grooves 26 are formed in the surface of the Al foil layer 24 and cause an electrode material to contact the highly conductive metal layer 22. Here, the grooves 26 are formed by cutting the Al foil layer 24, and the surfaces of grooves 26 of the Al foil layer 24 are roughened.

The grooves 26 may be formed by etching in order to expand the contact area of the Al foil layer 24 with the electrode material. The roughened surface of the Al foil layer 24 may increase the amount of electrode material of the first and second electrode layers 42 and 44 laminated on the Al foil layer 24 to a maximum extent. This contributes to a reduction in ESR existing between the Al foil layer 24 and the electrode material.

Since the electrode material directly contacts the high conductive metal 22 that has a higher conductivity than the Al foil layer 24, generated charges can move through the highly conductive metal layer 22, thereby further reducing the ESR.

By reducing the ESR of an electric double layer capacitor in the above-described manner, a high output power density can be enhanced, which is one of advantages of the electric double layer capacitor.

The metal case 30 provides a space allowing the internal electrode cell 70 to be received in the electrolyte solution 34, and includes collector terminals 32a and 32b exposed to the outside for surface-mounting on a board. Such an electric double layer capacitor 10 may be applied not only to a chip type but also to a coin type.

In the event that the electric double layer capacitor 10 is surface-mounted, the internal electrode cell 70 needs to be protected from a high temperature of about 260° C. in the surface-mounting, and a liquid electrolyte must be prevented from leaking. In this regard, the case is preferably formed of a metal material rather than resin such as an epoxy.

The electrode material of the first and second electrode layers 42 and 44 may utilize a polarizable electrode material, such as activated carbon having a relatively high specific surface area. The first and second electrode layers 42 and 44 are impregnated with an electrolyte solution such as an aqueous sulfuric acid solution, thereby serving as charge layers.

The first and second electrode layers 42 and 44 may be produced by forming an electrode material mainly formed of activated carbon powder into a solid type sheet, or by fixing an electrode material slurry onto the current collector 20.

The electrode material may include a highly conductive polymer material directly contacting the highly conductive metal layer 22, and an activated carbon electrode material coated on the highly conductive polymer material. In detail, the highly conductive polymer material may be laminated first on the grooves 26 in the Al foil layer 24, and then coated with the activated carbon electrode material (see FIG. 6).

The separator 50 may be formed of a porous material in order to enable the transport of ions. The separator 50 may be formed of a material such as polypropylene, polyethylene, glass fiber or the like.

Hereinafter, a method of manufacturing an electrode for an electric double layer capacitor, according to an exemplary embodiment of the present invention, will be described.

FIGS. 4A through 4C are schematic views illustrating a method of manufacturing an electrode for an electric double layer capacitor, according to an exemplary embodiment of the present invention.

Referring to FIGS. 4A through 4C, a highly conductive metal layer 22 is provided on the Al foil layer 24 to thereby prepare a current collector 20. Grooves 26 are formed in the surface of the Al foil layer 24 so as to communicate with the highly conductive metal layer 26.

After the grooves 26 are formed in the Al foil layer 24, the Al foil layer 24 may be disposed on the highly conductive metal layer 22. Thus, the lamination order of the Al foil layer 24 and the highly conductive metal layer 22 and the formation order of the grooves 26 may be changed.

Here, in the current collector 20, the highly conductive metal layer 22 may be interposed between the Al foil layers 24. The description of the kind of highly conductive metal layer 22 is substituted with the above description.

As shown in FIG. 4A, the grooves 26 are formed by cutting the surface of the Al foil layer 24. Then, as shown in FIG. 4B, the surfaces of the grooves 26 of the Al foil layer 24 are etched be roughened. In FIG. 4B, reference numeral 28 indicates an etched surface formed by the etching.

As shown in FIG. 4C, an electrode material is injected into the grooves 26 of the roughened Al foil layer 24, thereby coating the grooves 26 and the Al foil layer 24 with the electrode material.

When the surface of the Al foil layer 24 is roughened in the electric double layer capacitor 10 manufactured in the above-described manner, the amount of electrode material of the first and second electrode layers 42 and 44 laminated on the Al foil layer 24 may increase to a maximum extent, thereby reducing ESR existing between the Al foil layer 24 and the electrode material.

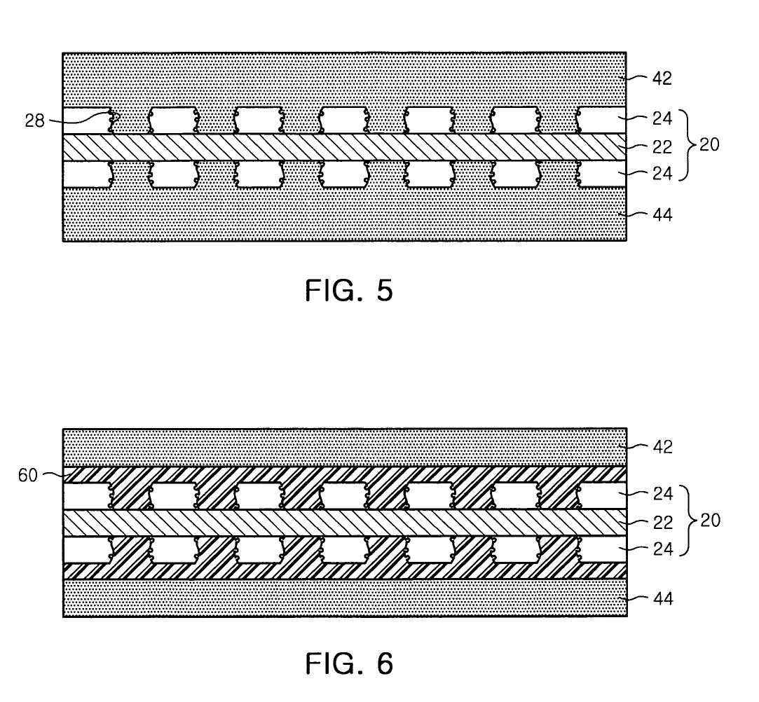

Since the electrode material directly contacts the highly conductive metal layer 22 which has a higher conductivity than the Al foil layer 24, generated charges can move through the highly conductive metal layer 22 to thereby further reduce ESR. FIG. 5 is a schematic view illustrating the flow of charges in the capacitor for an electric double layer capacitor manufactured according to an exemplary embodiment of the present invention.

A reduction in the ESR of an electric double layer capacitor may be contribute to enhancing high output power density, which is one of advantages of the electric double layer capacitor.

FIG. 6 is a schematic view illustrating that a highly conductive polymer material is applied to the Al foil layers before the electrode layers are formed of an activated carbon electrode material in manufacturing an electrode for an electric double layer capacitor according to an exemplary embodiment of the present invention.

Referring to FIG. 6, when the electrode for an electric double layer capacitor is in the state depicted in FIG. 4B, the highly conductive polymer material 60 is injected before the activated carbon electrode material so that the highly conductive polymer material directly contacts the highly conductive metal layer. This further lowers the ESR of the electric double layer capacitor and increases its high output power density.

As set forth above, in an electrode for an electric double layer capacitor, a method of manufacturing the same, and an electric double layer capacitor according to exemplary embodiments of the invention, the current collector includes the highly conductive metal layer on the Al foil layer, and the highly conductive metal layer directly contacts the electrode material. Consequently, charge-transfer resistance can be reduced.

Furthermore, a highly conductive polymer material is interposed between the current collector and the electrode material, thereby implementing low ESR and high output power in an electric double layer capacitor.

While the present invention has been shown and described in connection with the exemplary embodiments, it will be apparent to those skilled in the art that modifications and variations can be made without departing from the spirit and scope of the invention as defined by the appended claims.

What is claimed is:

1. An electrode for an electric double layer capacitor, the electrode comprising:
a current collector including an aluminum (Al) foil layer and a highly conductive metal layer having a higher conductivity than Al and laminated on the Al foil layer;
a groove formed in the Al foil layer to cause the highly conductive metal layer to contact an electrode material; and
an electrode layer formed of the electrode material on the groove and the Al foil layer.

2. The electrode for an electric double layer capacitor of claim 1, wherein the groove of the Al foil layer has a rough surface.

3. The electrode of claim 1, wherein the groove is formed by using etching to expand a contact area of the Al foil layer with the electrode material.

4. The electrode for an electric double layer capacitor of claim 1, wherein the current collector includes another Al foil layer laminated on the highly conductive metal layer on the Al foil layer.

5. The electrode for an electric double layer capacitor of claim 1, wherein the highly conductive metal layer is formed of any one selected from the group consisting of Cu, Ag, Au and Pt.

6. The electrode for an electric double layer capacitor of claim 1, wherein the electrode material includes:
a highly conductive polymer material directly contacting the highly conductive metal layer; and
an activated carbon electrode material coated on the polymer material.

7. An electric double layer capacitor comprising:
a plurality of electrode cells, each including a current collector including an Al foil layer and a highly conductive metal layer having a higher conductivity than the Al and laminated on the Al foil layer, electrode layers each formed of an electrode material contacting the highly conductive metal layer, and a separator separating the electrode layers;
an internal electrode cell formed by successively laminating the plurality of electrode cells; and
a metal case filled with an electrolyte solution and receiving the internal electrode cell.

8. The electric double layer capacitor of claim 7, wherein a groove is formed in the Al foil layer, and has a rough surface.

9. The electric double layer capacitor of claim 8, wherein the groove is formed using etching to expand a contact area of the Al foil layer with the electrode material.

10. The electric double layer capacitor of claim 7, wherein the current collector includes another Al foil layer laminated on the highly conductive metal layer disposed on the Al foil layer.

11. The electric double layer capacitor of claim 7, wherein the highly conductive metal layer is formed of any one selected from the group consisting of Cu, Ag, Au and Pt.

12. The electric double layer capacitor of claim 7, wherein the electrode material includes:
a highly conductive polymer material directly contacting the highly conductive metal layer; and
an activated carbon electrode material coated on the polymer material.

13. A method of manufacturing an electrode for an electric double layer capacitor, the method comprising:
providing a highly conductive metal layer on an Al foil layer to prepare a current collector;
forming a groove in a surface of the Al foil layer, the groove communicating with the highly conductive metal layer; and
injecting an electrode material into the groove to coat the groove and the Al foil layer with the electrode material.

14. The method of claim 13, wherein the forming of the groove in the surface of the Al foil layer includes roughening the surface of the groove of the Al foil layer by using etching.

15. The method of claim 13, wherein the current collector includes another Al foil layer laminated on the highly conductive metal layer disposed on the Al foil layer.

16. The method of claim 13, wherein the highly conductive metal layer is formed of any one selected from the group consisting of Cu, Ag, Au and Pt.

17. The method of claim 13, wherein the electrode material includes:
a highly conductive polymer material directly contacting the highly conductive metal layer; and
an activated carbon electrode material coated on the polymer material.
